(19) United States
(12) Patent Application Publication
(10) Pub. No.: US 2026/0009912 A1
(43) Pub. Date: Jan. 8, 2026

(54) METHOD FOR ASSESSING THE SEISMIC RISK ON EXISTING BUILDINGS

(71) Applicant: M.T. RICCI S.R.L., MILAN (MI) (IT)

(72) Inventors: Leonardo RICCI, Bologna (BO) (IT); Sergio SENTINELLI, Torino (TO (IT)

(21) Appl. No.: 18/907,096

(22) Filed: Oct. 4, 2024

(30) Foreign Application Priority Data
Jul. 4, 2024 (IT) 102024000015397

(51) Int. Cl. G01V 1/01; G06N 20/20

(52) U.S. Cl. CPC G01V 1/01; G06N 20/20

(57) ABSTRACT

Method for assessing the seismic risk on existing buildings, comprising the following steps:
a) identifying a set (N) of existing buildings to assess;
b) acquiring for all existing buildings belonging to said set (N) qualitative data relating to the formal and construction features of said buildings;
c) processing said qualitative data with a rapid analysis method based on qualitative criteria to assess the seismic vulnerability, and the related basic seismic risk, of all existing buildings belonging to the set (N);
d) selecting in an organized manner a subset(S) comprising 25% to 33% of buildings of the set (N);
e) acquiring for all the buildings of the subset(S) a plurality of analytical parameters;
f) processing said plurality of analytical parameters with a scientific analysis method based on quantitative criteria to assess the vulnerability and the basic seismic risk of all the buildings of the subset(S);
g) selecting in an organized manner a learning sample (A) comprising 70% to 80% of the buildings of the subset(S), and deriving by subtraction a verification sample (V) comprising 20% to 30% of buildings of the subset(S);
h) using an AI-based machine learning model entering into an algorithm, for each building included in said learning sample (A), at least a part of said plurality of analytical parameters and the corresponding seismic vulnerability and basic seismic risk results already obtained with the scientific analysis method referred to in step f), to generate a statistical model for predicting seismic vulnerability and basic seismic risk universally applicable to any building in the set (N);
i) applying said statistical prediction model to the buildings of the verification sample (V) using as input data the same part of said plurality of analytical parameters used for learning sample (A), and obtaining as output data calculated values of seismic vulnerability and basic seismic risk;
l) comparing said values calculated as output from said statistical prediction model referred to in step i) with the corresponding values of seismic vulnerability and basic seismic risk obtained by applying the scientific analysis method referred to in step f), and determining a degree of accuracy, precision and sensitivity APS of the statistical prediction model;
m) if said degree of APS has a value greater than a pre-established value, applying the same validated statistical prediction model to the remaining part of the buildings of the set (N) on which the scientific analysis method has not been applied;
n) if said degree of APS has a value lower than said pre-established value, increasing the number of existing buildings belonging to the subset(S) and reiterating steps e) to l) until the statistical prediction model is validated.

### TECHNICAL FIELD

The present invention is aimed to the building sector and relates to a method for assessing the seismic risk on existing buildings.

### BACKGROUND ART

Seismic risk, determined by the combination of hazard H, vulnerability V and exposure E, is the measurement of the damage expected in a given interval of time, based on the type of seismicity, the resistance of buildings and use/occupancy of the building being assessed according to the expression R=H×V×E.

Hazard indicates the frequency and force with which earthquakes occur, and is a physical feature of the territory; vulnerability indicates the poor capacity or incapacity of a building to withstand seismic actions: the more vulnerable a building is (for type, inadequate design, poor quality of the materials and construction methods, poor maintenance), the greater the consequences in terms of damage will be. Exposure indicates the greater or lesser presence of assets/people exposed to the risk, i.e., the possibility of economic damage and the loss of human lives.

Assessing the seismic risk of entire stocks of existing buildings, owned and/or managed by private subjects (Public Organizations, banks, insurance companies, railways, motorways, industries, etc.), makes it possible to learn the risks resulting from a seismic event, and to plan the use of economic resources to be allocated to interventions to reduce this risk over time.

To date, among others, two possible investigation methods aimed at assessing the seismic risk of existing buildings are known and already applied:
a rapid analysis method consisting in an approach of macroseismic type and which is based on the contents of the European Macroseismic Scale (EMS98) integrated with the contents of the Suitability and Damage in Seismic Emergency (AeDES) sheets; seismic vulnerability is derived from rapid analysis of the formal and construction features of the building; therefore, assessment of the risk class is based on qualitative criteria;
a conventional analysis method, defined according to the “Guidelines for the seismic classification of buildings” approved with Decree no. 58 of 28 Feb. 2017, and subsequent amendments and integrations (decree no. 65 of 7 Mar. 2017 and no. 24 of 9 Jan. 2020 of the Ministry of Infrastructure and Transport), in which assessment of seismic vulnerability and seismic risk is methodologically more complex and is based on quantitative analyses.

A correct seismic risk reduction strategy, relating to large building stocks, must necessarily pass through an initial rapid screening of this stock, through the application of general qualitative analyses for assessment of the seismic risk class. Rapid assessment is suitable, as conventional methods are based on the performance of complex and laborious analyses and investigations. Therefore, it is very useful for these complex and costly analyses to be adequately addressed based on the results of a first rapid analysis.

Preliminary application of the rapid method allows a scale of priorities to be established (from maximum risk to minimum risk), thereby permitting more rational and effective use of the resources for the subsequent targeted application of the conventional method.

However, although assessment of the seismic risk of a building with the aforesaid methods, first rapid and then conventional, can be carried out easily by expert operators, it is nonetheless an activity that takes some time for data collection and analysis. The hypothesis of being able to assess all the buildings present in a given territorial context or belonging to a vast building stock owned by an organization, would require a great deal of time and teams of technicians working full time.

In recent years a simplified method, aimed at replacing the conventional method, has been developed: this simplified method consists in the application of the so-called “expert judgement method”, defined and prepared by the National Group for Earthquake Defence (Gruppo Nazionale Difesa dai Terremoti-GNDT), and is based on a quantitative assessment of a plurality of parameters.

The methods based on the judgement of experts consist in attributing each building with a vulnerability index, i.e., a number determined according to certain rules, based on indicators that are no longer interpreted with typological meaning, but as symptoms of suitability (or lack of suitability) to withstand seismic actions (such as efficiency of the connections, strength of the materials, morphological regularity).

The seismic vulnerability of each building is therefore expressed through a vulnerability index associated with each parameter, the sum of which allows the buildings assessed to be ordered according to a conventional and relative scale.

Although this simplified method is effectively easier and faster to apply than the conventional method, it is still necessary to examine with this method all the buildings belonging to entire building stocks, one by one, with inevitable long performance times.

### Presentation of the Invention

The main aim of the invention is, therefore, to define a method for assessing the seismic risk on existing buildings that integrates conventional analyses with innovative technologies that apply AI, to offer a more accurate and rapid picture of the seismic risk of entire existing building stocks.

In more general terms, an object of the invention is also to provide the implementation of services, aimed at processing maps of the seismic vulnerability and of the seismic risk of territories or of specific building stocks (schools, hospitals, important buildings, places of work, etc.) according to the “Guidelines for the seismic classification of buildings” approved with Decree no. 58 of 28 Feb. 2017, and subsequent amendments and integrations (decree no. 65 of 7 Mar. 2017 and no. 24 of 9 Jan. 2020 of the Ministry of Infrastructure and Transport), through the computer-assisted completion of a specific questionnaire and subsequent application of the assessment method according to the invention.

The objects are achieved with a method for assessing the seismic risk on existing buildings characterized in that it comprises the following steps:
a) identifying a set N of existing buildings to assess;
b) acquiring for all existing buildings belonging to said set N qualitative data relating to the formal and construction features of said buildings;
c) processing said qualitative data with a rapid analysis method based on qualitative criteria to assess the seismic vulnerability, and the related basic seismic risk, of all existing buildings belonging to said set N;
d) selecting in an organized manner a subset S comprising 25% to 33% of existing buildings of said set N;
e) acquiring for all existing buildings belonging to said subset S a plurality of analytical parameters;
f) processing said plurality of analytical parameters with a scientific analysis method based on quantitative criteria to assess the seismic vulnerability, and the related basic seismic risk, of all existing buildings belonging to said subset S;
g) selecting in an organized manner a learning sample A comprising 70% to 80% of existing buildings of said subset S, and deriving by subtraction a verification sample V comprising 20% to 30% of existing buildings of said subset S;
h) using an AI-based machine learning model entering into an algorithm, for each existing building included in said learning sample A, at least a part of said plurality of analytical parameters and the corresponding seismic vulnerability and basic seismic risk results already obtained with the scientific analysis method referred to in step f), to generate a statistical model for predicting seismic vulnerability and basic seismic risk universally applicable to any existing building in the set N;
i) applying said statistical prediction model to the existing buildings included in said verification sample V using as input data the same part of said plurality of analytical parameters used for the learning sample A, and obtaining as output data calculated values of seismic vulnerability and basic seismic risk;
l) comparing said values calculated as output from said statistical prediction model referred to in step i) with the corresponding values of seismic vulnerability and basic seismic risk obtained by applying the scientific analysis method referred to in step f), and determining a degree of accuracy, precision and sensitivity (APS) of the statistical prediction model;
m) if said degree of accuracy, precision and sensitivity (APS) has a value greater than a pre-established value, applying the same validated statistical prediction model to the remaining part of the existing buildings belonging to the set N on which the scientific analysis method has not been applied;
n) if said degree of accuracy, precision and sensitivity (APS) has a value lower than said pre-established value, increasing the number of existing buildings belonging to the subset S and reiterating steps e) to l) until the statistical prediction model is validated.

Further aspects of the method for assessing the seismic risk according to the invention are described in the dependent claims.

The assessment method of the invention through the use of an AI-based machine learning model offers the main advantage of significantly reducing both the times and the costs relating to assessment of the seismic risk on existing buildings that belong to the same municipality or organization, or territorial context or building stock.

The assessment method according to the invention identifies the seismic risk with a probabilistic approach based on data of hazard, seismic vulnerability and structural type of the buildings.

Using an AI-based machine learning model we obtain a statistical prediction model with which it is possible to explode the analysis to much larger volumes of data and, therefore, to a much larger number of buildings, on which to plan more efficient and targeted maintenance interventions than possible with conventional methods for assessing the seismic risk.

A further important advantage, above all for large building stocks belonging to public or private organizations or corporations, derives from a rational use of resources to be allocated to retrofit projects or interventions to reduce seismic risk by one or more classes.

Further, with the AI-based machine learning model, it is possible to work with a larger number of variables without requiring for them all to be available as input data or without requiring to map them in advance if these variables are missing.

### BRIEF DESCRIPTION OF THE DRAWINGS

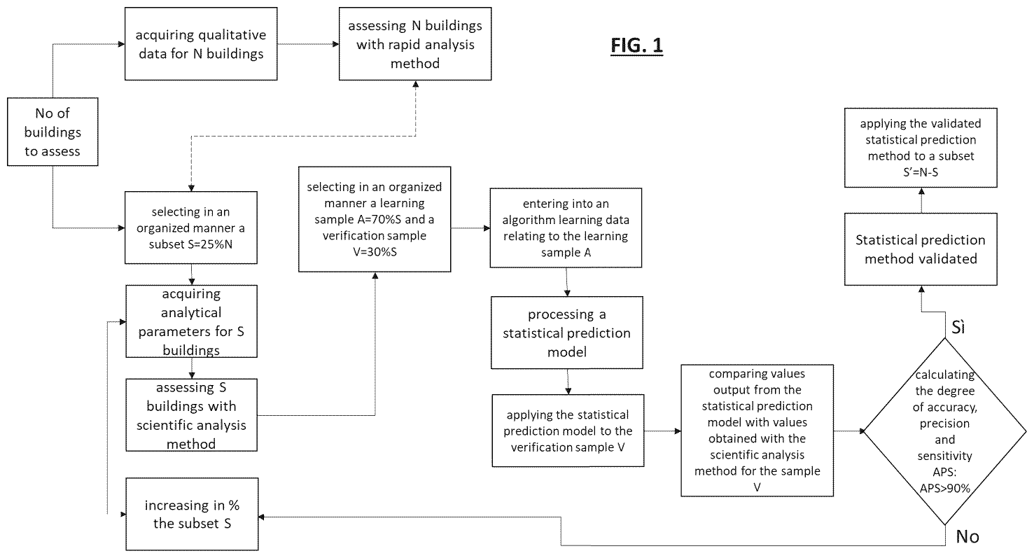

The advantages of the invention will be more apparent from the description below, which describes a preferred embodiment, provided by way of non-limiting example, and with the aid of FIG. 1, which schematically illustrates, by means of a flow chart, the execution steps of a method for assessing the seismic risk on existing buildings according to the invention.

### DETAILED DESCRIPTION OF A PREFERRED EMBODIMENT OF THE INVENTION

With reference to the flow chart of FIG. 1, this illustrates a method for assessing the seismic risk on existing buildings belonging to a set N of existing buildings to be assessed, for example belonging to a building stock or to a territory.

A first step consists in acquiring for all existing buildings belonging to said set N qualitative data relating to the formal and construction features of said buildings.

Said qualitative data are selected from data relating to:
masonry (type I masonry with irregular structure and of poor quality; type II masonry with regular structure and of good quality; presence of isolated columns; presence of typology with mixed structure; reinforced masonry, etc.);
horizontal elements, if identified (vaults without ties, vaults with ties, beams with deformable slab, beams with semi-rigid slab, beams with rigid slab, etc.);
reinforced concrete structures (plan and elevation regularity, presence and type of infill walls, etc.);
roofing assessed on weight factor and on any thrusting effect on the supporting/constraining perimeter structures (thrusting heavy, non-thrusting heavy, thrusting light, non-thrusting light);
morphology of the land and foundation failures;
current state relating to pre-existing damages to structural and non-structural elements (light damage, medium-to-serious damage, very serious damage).

The subsequent step consists in processing said qualitative data with a rapid analysis method based on qualitative criteria to assess the seismic vulnerability, and the related basic seismic risk, of all existing buildings belonging to said set N.

Said rapid analysis method is based on the European Macroseismic Scale (EMS98) integrated with the contents of the Suitability and Damage in Seismic Emergency (AeDES) sheets.

To apply said rapid analysis method, the individual qualitative data required and acquired, for example, during an inspection, must be entered in the dedicated tables. Through the processing of said qualitative data, using calculations and logic functions with specific formulas, the numerical values of each component analysed, belonging to the datum being examined, are defined. This processing assigns, for each qualitative datum, a corresponding seismic vulnerability class; the sum of all the seismic vulnerability classes defines the vulnerability of the building. This value multiplied by the seismic hazard of the site defines the so-called “basic seismic risk “R′=H×V” and from this the seismic risk class is deduced.

A subsequent step consists in selecting in an organized manner a subset S comprising 25% to 33% of existing buildings of said set N; selection takes place based on a statistical principle of “random sampling” to avoid any type of distortion caused by prejudice.

The term “random sampling” is meant as a statistical technical term describing a sample that ensures that all building classes and types are included in this sample. This requirement is obtained by first assessing all the buildings with the rapid method and selecting the sample in a balanced manner for the subsequent more in-depth assessment, using a scientific analysis method. Therefore, all types of building and risk classes found through application of the rapid method are included in the subset S.

For all existing buildings belonging to said subset S a plurality of analytical parameters must be acquired.

Said analytical parameters are parameters in part detected on site through inspection and in part obtained statistically.

The analytical parameters vary in part according to whether the buildings are masonry buildings, have aggregates, or are reinforced concrete buildings.

For masonry buildings, said analytical parameters comprise:
P1 type and organization of the resistant system: assesses the degree of organization of the vertical elements, regardless of material and of the features of the single masonry elements; the significant element is the presence and efficacy of the connections between orthogonal walls, such as to ensure the efficiency of the box behaviour of the wall;
P2 quality of the resistant system: assesses the type of material and shape of the elements forming the masonry elements, the homogeneity of material and of size for the whole extension of the wall;
P3 conventional resistance: relating to a verification floor assesses the number of floors starting from the verification floor (included), the average covered area above the verification floor, the total area of the resisting elements in two orthogonal directions;
P4 position of the building and foundation: visual investigation assesses the consistency of the ground, the slope % of the ground, any foundations at different heights, unbalanced forces of embankments;
P5 horizontal elements: assesses the slab function and high in-plane deformation stiffness, the effective connection to the resisting vertical elements;
P6 planimetric configuration: assesses the shape in plan and, for rectangular buildings, the ratio between dimensions of the shorter side and of the longer side is significant;
P7 elevation configuration: assesses the presence of porticos, loggias and roof terraces, towers or turrets;
P8 maximum distance between walls: assesses the presence of load bearing walls intersected by transverse walls placed at too great a distance from one another;
P9 roofing: assesses the worst type of roofing present (thrusting, “minimally thrusting”, non thrusting) the presence or absence of ring beams, the presence or absence of ties, the permanent load of the roof, the support length of the roofing;
P10 non-structural elements: assesses fixtures, appendages and overhangs that can cause injury to persons or damage to property by falling;
P11 current state, i.e., their state of preservation.

For buildings in aggregate, said analytical parameters further comprise:
P12 interactions in height;
P13 interactions in plan;
P14 presence of staggered floors between building and adjacent buildings;
P15 typological and structural discontinuities;
P16% difference in holes in the façade.

For reinforced concrete buildings, said analytical parameters comprise:
P′1 type and organization of the resistant system: assesses the resistance offered by the single resisting elements in the direction identified as the worst, and classifies the structure as stiff-resistant structure, stiff-fragile/deformable-resistant structure, stiff-fragile/deformable-weak structure;
P′2 quality of the resistant system: assesses type and quality of the materials used, execution features of the work, design features of the work;
P′3 conventional resistance: takes account of a sort of degree of safety relative to seismic forces of reference;
P′4 position of the building and foundation: assesses the existence or absence of foundations and their typology, features of the ground;
P′5 horizontal elements: assesses the slab function and high in-plane deformation stiffness, effective connection to the resisting vertical elements;
P′6 planimetric configuration: assesses mass and stiffness distribution, and the shape in plan;
P′7 elevation configuration;
P′8 connections and critical elements: the connection areas between structural elements (beam-column nodes, beam-floor joining areas, foundation-column or wall nodes, joints between structural elements if prefabricated) are defined as connections, while all those elements of primary importance for resistance to seismic actions are defined as critical elements;
P′9 elements with low ductility: takes account of cases in which the behaviour or the building or parts thereof is made critical by fragile elements and/or those that are very stiff and have relatively low ductility;
P′10 non-structural elements: elements that can fall on the outside (infill walls, cornices, chimneys, parapets), and elements that can only fall on the inside (partition walls, furniture, objects hanging from the ceiling or from the partition walls);
P′11 current state: assesses the integrity of resistant elements in elevation (columns, walls, infill walls, beams, floors), of the resistant elements in the foundation, and of the non-structural elements.

The subsequent step consists in processing said plurality of analytical parameters with a scientific analysis method based on quantitative criteria to assess the seismic vulnerability, and the related basic seismic risk, of all existing buildings belonging to said subset S.

Said scientific analysis method is based on the so-called “expert judgement method” defined and prepared by the National Group for Earthquake Defence (Gruppo Nazionale Difesa dai Terremoti-GNDT).

To apply the scientific analysis method it is also necessary to enter the single parameters required, acquired for example during an inspection, or in part obtained statistically, in dedicated tables.

Through processing of said parameters, using calculations and logic functions with specific formulas, the numerical values of each component analysed, belonging to the parameter being examined, are defined. This analysis assigns, for each parameter, the corresponding vulnerability class; the sum of these vulnerability classes defines the vulnerability of the building. Once again, this value multiplied by the seismic hazard of the site defines the so-called “basic seismic risk “R′=H×V” and from this the seismic risk class is deduced.

Advantageously, an original variation consists in substituting the vulnerability classes with the numerical values as defined by the “expert judgement” method, and the seismic zones with the maximum values of the corresponding maximum ground acceleration values, correlated to the hazard, so as to have numerical ranges through which to define the seismic risk classes.

As mentioned above, the scientific analysis method is performed on a subset S, comprising 25% to 33% of the buildings belonging to the initial set N.

The subsequent step of the assessment method according to the invention consists in creating a statistical prediction model with which to assess the remaining buildings belonging to the set N and not assessed with the scientific analysis method.

To this end, the method according to the invention uses an AI-based machine learning model.

Specifically, said machine learning model is supervised learning.

The supervised learning consists of 2 steps:
a learning step (defined “training”), in which the algorithm is trained providing it with a series of input data the answer to which (output data) is already known; in the learning step a function, a statistical model, that links the independent variable to the dependent variable, is interpolated;
a test and verification step (defined “prediction”), in which based on the data learned in the learning step, the algorithm is able to generate predictions; the statistical model learned in the learning step is generalized, and the algorithm can apply the statistical model learned to new input data.

With supervised learning, the models are trained to recognize and allocate the input data to specific predefined classes

Classification analysis is the supervised learning most fitting for the application in question: in fact, classification algorithms provide a result expressed as a discrete value, which indicates that the object belongs to a specific class (in the case in question the seismic vulnerability class).

As the parameters used to calculate the vulnerability can only assume discrete values corresponding to classes A, B, C, D . . . , the classification algorithm that seems most suitable is a so-called decision tree algorithm.

To create a statistical prediction model it is therefore necessary to select in an organized manner a learning sample A comprising 70% to 80% of existing buildings of said subset S, and derive by subtraction a verification sample V comprising 20% to 30% of said subset S.

Also in this case, the learning sample A is selected so as to guarantee that all building classes and types are included therein.

Using an AI-based machine learning model as described above, and entering into an algorithm, for each existing building included in said learning sample A, a series of learning data including at least a part of said plurality of analytical parameters and the corresponding seismic vulnerability and basic seismic risk results already obtained with the scientific analysis method, to generate a statistical model for predicting seismic vulnerability and basic seismic risk universally applicable to any existing building in the set N.

Said analytical parameters, which are entered in the algorithm as input data, are in part parameters detectable on the field, and in part parameters obtainable by interference, using Chi-Square analysis, if they cannot be obtained deterministically.

The most significant parameters are defined by ANOVA statistical analysis and are those that have a greater impact on the variance of the result, i.e., seismic vulnerability and basic seismic risk, and are in order P1/P′1, P4/P′4, P6/P′6 and P7/P′7, from which against Chi-square analysis P2/P′2, P8/P′8 and P11/P′11 are correlated.

To generate the statistical prediction model only the most significant parameters are extrapolated, so as to drastically reduce all the data collection work. Advantageously, the parameters P1/P′1, P4/P′4, P6/P′6 and P7/P′7, which are parameters that describe, best and in a more consistent manner, the variance of vulnerability, are assessed on site, while the values of the parameters P2/P′2, P8/P′8 and P11/P′11 are determined in a probabilistic-statistical manner so as to be able to feed the algorithm with a greater number of values; the choice of the parameters P3/P′3, P5/P′5, P9/P′9 and P10/P′10 instead derives from consolidated experience in the civil engineering field.

The statistical prediction model learned in the learning step is then generalized and can be applied to the existing buildings included in said verification sample V using as input data the same part of said plurality of analytical parameters used for the learning sample A, and obtaining as output data calculated values of seismic vulnerability and basic seismic risk.

The goodness of the results obtained by applying the statistical prediction model is assessed by a so-called confusion matrix.

Said confusion matrix is obtained by comparing said output values calculated by said statistical prediction model with the corresponding values of seismic vulnerability and basic seismic risk obtained applying the scientific analysis method.

Three metrics with which to assess the reliability of the results and determine a degree of accuracy, precision and sensitivity APS of the statistical prediction model are obtained from the matrix.

If said degree of accuracy, precision and sensitivity (APS) has a value greater than a predetermined value, for example, from 80% to 90%, the statistical prediction model is considered validated, and said validated model can be applied to the remaining part of the buildings belonging to the set N (i.e., a subset S′ comprising from 67% to 75% of existing buildings of said set N) to which only the rapid analysis method and not the scientific analysis method has been applied.

If said degree of accuracy, precision and sensitivity (APS) has a value lower than said pre-established value, the number of existing buildings belonging to the subset S must be increased to enrich the AI-based machine learning model.

The model is more precise when the volume of data that can be used for learning increases. When the volume of data increases significantly, the same analyses shown will be performed in a more detailed manner in order to determine the capacity, robustness and limits of the statistical prediction model when having quantitatively and qualitatively different combinations of input data available.

As repeatedly stated, the method for assessing the seismic risk according to the invention, by applying an AI-based machine learning model, makes large-scale and timely analysis and assessment of the seismic vulnerability, and hence of the seismic risk class of each single building, possible. Speeding up of all the assessment work is the added value brought by the method according to the invention.

By way of example, a simulation is given of the execution times of an assessment of the seismic vulnerability of the building stock of municipalities in the area of the Phlegraean fields, by applying the standard assessment methods and applying the method according to the invention.

The “area of intervention” was identified in the areas of the municipalities of Pozzuoli, Bacoli and Napoli (Bagnoli district and part of the municipality of Soccavo/Pianura and of Posillipo) most affected by the phenomenon of bradyseism and hence by seismicity and deformation of the ground. The “area of intervention” was identified based on localization of the epicentres of the seismic events with magnitude of a duration greater than or equal to 2, occurring in the Phlegraean area starting from 1983; of uplifts equal to or greater than 10 cm since 2015 (corresponding to around 20 cm since 2006).

The “area of intervention” includes a total population of 84,961 people and a total number of residential buildings (estimated) of 15,516.

Assuming:
average time estimated for analysis with the conventional method: 14 days/building;
average time estimated for analysis with the simplified method: 2 days/building;
average time estimated for completing the information questionnaire on the qualitative data relating to formal and construction features of buildings to be used to apply the rapid analysis method: 5 buildings/day.

The tables set down below compare the times to obtain an assessment on all buildings in the “area of intervention” applying the conventional method, the simplified method and the assessment method of the invention (which consists of a rapid analysis method applied to 100% of the buildings, a scientific analysis method applied to 25% of the buildings, and then entrusts an AI-based machine learning model with assessment of the remaining 75% of the buildings).

| | Conventional method | | | Simplified method | | |
|---|---|---|---|---|---|---|
| | no. of days | no. of days | | no. of days | no. of days | |
| Number of | for one | for 50 | | for one | for 50 | |
| buildings N | technician | technicians | | technician | technicians | |
| 15,516 | 217,224 d | 4,344 | d | 31,032 d | 621 | d |
| | | 11.90 | years | | 2 | years |

| | Method of the invention | | |
|---|---|---|---|
| | no. of days for | no. of days for | |
| No. of buildings | one technician | 50 technicians | |
| N = 15,516 | 3103 d | 62 d | Rapid analysis |
| | | | method |
| S = 25% | 7758 d | 155 d | Scientific |
| N = 3879 | | | analysis |
| | | | method |
| | | 217 d = 7 | |
| | | months | |

It is evident how with the assessment method according to the invention it is possible to obtain timely analysis and assessment of the seismic vulnerability, and hence of the seismic risk class, of each single building of the “area of interest”.

1. Method for assessing the seismic risk on existing buildings, characterized in that it comprises the following steps:
a) identifying a set N of existing buildings to assess;
b) acquiring for all existing buildings belonging to said set N qualitative data relating to the formal and construction features of said buildings;
c) processing said qualitative data with a rapid analysis method based on qualitative criteria to assess the seismic vulnerability, and the related basic seismic risk, of all existing buildings belonging to said set N;
d) selecting in an organized manner a subset S comprising 25% to 33% of existing buildings of said set N;
e) acquiring for all existing buildings belonging to said subset S a plurality of analytical parameters;
f) processing said plurality of analytical parameters with a scientific analysis method based on quantitative criteria to assess the seismic vulnerability, and the related basic seismic risk, of all existing buildings belonging to said subset S;
g) selecting in an organized manner a learning sample A comprising 70% to 80% of existing buildings of said subset S, and deriving by subtraction a verification sample V comprising 20% to 30% of existing buildings of said subset S;
h) using an AI-based machine learning model entering into an algorithm, for each existing building included in said learning sample A, at least a part of said plurality of analytical parameters and the corresponding seismic vulnerability and basic seismic risk results already obtained with the scientific analysis method referred to in step f), to generate a statistical model for predicting seismic vulnerability and basic seismic risk universally applicable to any existing building in the set N;
i) applying said statistical prediction model to the existing buildings included in said verification sample V using as input data the same part of said plurality of analytical parameters used for learning sample A, and obtaining as output data calculated values of seismic vulnerability and basic seismic risk;
l) comparing said values calculated as output from said statistical prediction model referred to in step i) with the corresponding values of seismic vulnerability and basic seismic risk obtained by applying the scientific analysis method referred to in step f), and determining a degree of accuracy, precision and APS sensitivity of the statistical prediction model;
m) if said APS degree of accuracy, precision and sensitivity has a value greater than a pre-established value, applying the same validated statistical prediction model to the remaining part of the existing buildings belonging to the set N on which the scientific analysis method has not been applied;
n) if said degree of APS accuracy, precision and sensitivity has a value lower than said pre-established value, increasing the number of existing buildings belonging to the subset S and reiterating steps e) to l) until the statistical prediction model is validated.

2. Assessment method according to claim 1, characterized in that said qualitative data are selected from data relating to walls, horizontal elements, reinforced concrete structures, roofs, morphology of the ground and foundation failures, current state relating to pre-existing damage to structural and non-structural elements.

3. Assessment method according to claim 1, characterized in that said rapid analysis method is based on the European Macroseismic Scale (EMS9) integrated with the contents of the Suitability and Damage in Seismic Emergency (AeDES) sheets.

4. Assessment method according to claim 1, characterized in that, for masonry buildings, said analytical parameters include: type and organization of the resistant system (P1), quality of the resistant system (P2), conventional resistance (P3), position of the building and foundation (P4), horizontal elements (P5), planimetric configuration (P6), elevation configuration (P7), maximum distance between walls (P8), roofing (P9), non-structural elements (P10), current state (P11).

5. Assessment method according to claim 4, characterized in that, for aggregate buildings, said analytical parameters further comprise: interactions in height (P12), interactions in plan (P13), presence of staggered floors between the building and adjacent buildings (P14), typological and structural discontinuities (P15), % difference in holes in the facade (P16).

6. Assessment method according to claim 1, characterized in that, for reinforced concrete buildings, said analytical parameters include: type and organization of the resistant system (P′1), quality of the resistant system (P′2), conventional resistance (P′3), position of the building and foundation (P′4), horizontal elements (P′5), planimetric configuration (P′6), elevation configuration (P′7), connections and critical elements (P′8), elements with low ductility (P′9), non-structural elements (P′10), current state (P′11).

7. Assessment method according to claim 1, characterized in that said part of analytical parameters to be entered in said algorithm for the learning sample A includes parameters detectable on the field and parameters obtained by interference using Chi-Squared analysis.

8. Assessment method according to claim 1, characterized in that said scientific analysis method is based on the so-called “expert judgement method”.

9. Assessment method according to claim 1, characterized in that said machine learning model is supervised learning.

10. Assessment method according to claim 9, characterized in that said supervised learning includes a classification algorithm.

11. Assessment method according to claim 10, characterized in that said classification algorithm is a decision tree algorithm.

12. Assessment method according to claim 1, characterized in that said degree of accuracy, precision and APS sensitivity is obtained by applying a confusion matrix.

13. Assessment method according to claim 1, characterized in that said predetermined value of the degree of accuracy, precision and sensitivity APS is equal to 90%.
